(19) United States
(12) Patent Application Publication
(10) Pub. No.: US 2012/0136699 A1
(43) Pub. Date: May 31, 2012

(54) On-Line System of Coupon Placement and Redemption

(75) Inventors: Andrew McGovern MARTIN, Sausalito, CA (US); Sarah Christina Schloemer, Sausalito, CA (US)

(73) Assignee: COMMONKINDNESS INC, Sausalito, CA (US)

(21) Appl. No.: 13/305,704

(22) Filed: Nov. 28, 2011

Related U.S. Application Data
(60) Provisional application No. 61/417,852, filed on Nov. 29, 2010.

(51) Int. Cl. G06Q 30/02

(52) U.S. Cl. 705/14.1

(57) ABSTRACT

A coupon management system in which online or print coupons can be generated by manufacturers and accessed by shoppers wherein a portion of the coupon redemption value is automatically sent to charitable causes that the shopper has pre-selected, and wherein the coupons can be individually tracked to the specific shopper who has redeemed them. In this system, payment is based on actual coupon redemption, rather than on sales of simple print or webpage space, or upon coupons simply being viewed or printed by potential shoppers. This system enables manufacturers to access detailed consumer metrics.

### RELATED APPLICATION

The present invention claims priority to U.S. Provisional Patent Application 61/417,852, filed Nov. 29, 2010, entitled “On-line System Of Coupon Placement And Redemption”, the full disclosure of which is incorporated herein by reference in its entirety for all purposes.

### TECHNICAL FIELD

The present invention is related to systems for generating, distributing and tracking the redemption of online or print coupons and tracking who printed and redeemed each coupon.

### BACKGROUND OF THE INVENTION

Coupons have been around for years both in print and online forms. Unfortunately, the systems commonly used for producing and distributing these coupons have not been very sophisticated, and have many common problems. First of all, many coupons are generated, but only a few are actually redeemed by shoppers at retailers. Secondly, it is very difficult for manufacturers/advertisers to know or predict which coupons will be redeemed, and who will redeem them. Thus, placing coupons in front of potential shoppers is a game of chance with the manufacturers guessing on where best to display their coupons. In the case of coupons printed in magazines, newspapers or journals, the mechanisms through which payments are made from the manufacturers to the publishers who displayed the coupons offer no incentives for the publisher to promote actual coupon redemption.

For example, print publishers traditionally just sold their advertisers page space in which to print coupons in their magazines and periodicals. A simple problem with selling print space was that the print space is finite. Therefore, the magazine or newspaper could only sell a limited amount of its page space to its advertisers (i.e. manufacturers). The advertiser/manufacturer could thus only distribute a limited number of printed coupons (based upon the amount of page space it purchased and the total circulation of the publication). This is a poor advertising method for several reasons. First, studies have shown that the overwhelming majority of coupons are never redeemed. Second, there is no way to determine which particular shoppers redeem which particular coupons. This makes it hard to do successful targeted marketing. Therefore, the advertiser/manufacturer simply attempts to put coupons that appeal to certain select groups of people in certain magazines. For example, a restaurant would likely place their coupons in a local events magazine, whereas a deodorant company would likely place their coupons in a sports magazine. Third, coupons are traditionally placed in the publication in locations that are determined solely by the wishes of the editor and advertiser. There is little uniformity as to placement and the coupons are often hard to find. Shoppers may not find the preferred coupons they are looking for in the magazine. Typically, the magazine purchaser (i.e.: the shopper) doesn't even know where to find the coupons until after the magazine is purchased. Fourth, the newspapers or magazines simply sell the physical add space and do not receive any revenue from the actual redemption of the coupons.

Generating traditional print coupons required the advertiser/manufacturer to pay the publisher/distributor who actually includes the coupons in their magazine or journal. In addition, the advertiser/manufacturer pays the retailer when a shopper actually redeems the coupon. In the case of online coupons, the magazine publisher is removed. However, instead the advertiser/manufacturer now pays a website operator for its service (i.e.: for presenting printable coupons in an organized, central, searchable online format for shoppers to browse and download). However, current systems through which the website charges the advertiser/manufacturer are complex and/or offer poor incentives for coupon redemption.

For example, systems like “Coupons.com” first charge the advertisers/manufacturers a “load fee” to upload their coupons to their website. This is followed by a “print fee” that is charged whenever a shopper prints a coupon. A further problem with this model is that although it is possible to determine which shoppers print which coupons, it is still not possible to determine which coupons are actually redeemed. As a result, the advertisers/manufacturers are paying for advertising whether or not the advertising actually results in sales (i.e.: coupons actually being redeemed). In addition, it is hard for the advertiser/manufacturer to change or modify their coupons without paying more money to the website operator.

It would instead be desirable to overcome the above disadvantages. It would especially be desirable to tie the advertising payments directly to coupon redemptions. It would also be quite desirable to track which shoppers are redeeming which coupons, as this would enable much more potential for targeted advertising.

### SUMMARY

The present invention provides a comprehensive coupon management system having many advantages. Importantly, the present system permits individual coupons to be tracked in a manner such that the identity of the particular shopper redeeming each coupon can be recorded. As a result, targeted advertising is possible. Secondly, the present system has the novel advantage of financially supporting worthwhile charitable causes by directing money to particular charitable causes that individual shoppers have pre-selected to support. Thus, whenever a shopper redeems a coupon using the present system, a portion of the coupon redemption fee will be directed to the charity (or charities) they wish to sponsor. Since consumers need to register to select their favorite non profit they are providing their identification and other information. This shopper specific identification is encrypted onto the individual coupons they redeem. If there were no non profit benefit, shoppers would not register and there would be no ID nor ability for the present system to track the coupon. Therefore the Non profit benefit is what compels people to register and to redeem the coupons. If the person didn't register there is no way to track a coupon to a particular person so the present system can donate the portion of redemption revenue to the persons favorite non profit. Thirdly, payment from the advertiser/manufacturer is based on actual coupon redemptions (and not simply on shoppers viewing or printing coupons). It is to be understood that the term “manufacturer” as used herein refers without limitation to the producer or seller of any good or service that wishes to promote/advertise their good or service with coupons.

As can be seen, the present invention has something positive to offer all parties. The advertiser/manufacturer is rewarded by having a detailed record kept of which shoppers actually redeem which coupon, since each shopper's ID is encrypted on each coupon. This ID is used by the present system to reconcile an individual redeemed coupon with all of the information fields provided by a consumer when they register. For example, the present system knows what is the person's favorite non profit and this information can now be matched with what coupon they redeemed. If the person's favorite non profit is the ASPCA, the present system can be used to email future pet product coupons to them. If they redeem Natural toothpaste coupons, the present system knows that they might also be interested in future natural soap coupons. Finally, the present system can match all of the consumer's registration information with each individual redemption so that the present system would know, for example, that the person buys milk every 10 days and they should be targeted to receive a future soap or shampoo coupon a day or two before their soap runs out (as recorded from their soap coupon redemption patterns). The registration information is collected and reconciled with actual redemption information provided by the retailer (i.e.: time, store name location, deal terms) and the information on the coupon provided by the Advertiser (i.e.: the fields of information fields provided by the advertiser including the information on the coupon itself). Together the information tracking includes the fields provided by the consumer registration, the advertiser and the retailer. This is unprecedented and unique information as it allows the correlation of multiple fields of information from multiple sources and creates an extremely accurate and unprecedented profile of the consumer and their purchasing habits. This is of enormous value to the advertisers such as General Mills. General Mills currently spends more than $3 billion on advertising that may or may not be seen or incite a purchase. The present coupons cost a fraction of General Mills ad budget and result in a definite sale and unparalleled metrics describing their customers exact purchasing patterns and habits. This allows General Mills to focus advertising more accurately as they now know their customers better and know that they, for example, support the ASPCA.

This permits advertisers/manufacturers to develop very targeted marketing. In addition, the advertiser/manufacturer is only charged for actual coupon redemptions. Thus, they do not risk paying for an unsuccessful advertising campaign. Instead, they only pay a fee when the coupon is redeemed and they get a sale of the couponed product or service. The shopper is also rewarded since they know that a portion of the redemption fee that the advertiser/manufacturer pays the coupon management facility will be sent directly to the particular charities and charitable causes that they wish to support. Simply put, the shoppers save money while helping others. This offers a huge emotional attraction for shoppers to use the present system. Moreover, they are also presented with coupons in an easy to use, accessible, searchable online format. Lastly, the charitable causes are also rewarded as they receive funding easily and automatically. This allows them more time to focus on their charitable work (as opposed to having to spend excessive efforts hunting down donations from individuals). Finally, being an online system, another advantage is that an endless number of coupons can be designed, stored and accessed through the system's website and database or accessed through other devices such as mobile phones etc.

It is to be understood, however, that the present invention encompasses both online and print coupons. Moreover, the print coupons can be linked to the online coupons (for example by having a printed data field that can be scanned by a shopper using their smart phone to activate a web link).

It is also to be understood that the present coupons may be posted to a website, or to a widget, to a mobile application, social media network, etc.

In one aspect, the present invention provides a method of generating coupons, tracking coupon redemption and paying for coupon advertising based upon coupon redemption, comprising the steps of: (a) a manufacturer designing a coupon using an online coupon management system; (b) the manufacturer making the coupon available to a shopper; (c) the shopper redeeming the coupon at a retailer; (d) the retailer sending the redeemed coupon to a clearinghouse; (e) the clearinghouse making a report of the coupon redemption, wherein the report includes the identity of the shopper redeeming the coupon; (f) the report of the coupon redemption being sent from the clearinghouse to both the manufacturer and to the online coupon management system; (g) the manufacturer paying the retailer based upon the redemption of the coupon; and (h) the manufacturer paying the online coupon management system based upon the redemption of the coupon.

In another aspect, the present invention provides a coupon management system for generating, distributing and tracking coupons for payment of coupon advertising based upon coupon redemption, comprising: (a) a coupon design software module which operates an online interface through which manufacturers design coupons and store the coupons in a coupon database; (b) a charitable cause software module which operates an online interface through which charitable causes are entered into a charitable cause database and through which shoppers select preferred charitable causes from the charitable cause database; (c) a coupon selection software module which operates an online interface through which shoppers select preferred coupons stored in the coupon database; and (d) a coupon generation module that retrieves coupons selected by the shoppers and adds information to the coupons identifying the shopper who selected each coupon.

Preferably, also included is a coupon printing software module that prints the individual coupons with information printed thereon: (i) representing the good or service to which the coupon relates; (ii) representing the identity of the shopper who printed the coupon; and (iii) representing the charitable cause that has been selected by the shopper. As a result, the present invention encompasses physical printed coupons having both the identity of the shopper and the identity of the charitable cause they wish to support printed thereon. No existing coupon system generates a physical coupon having this information printed directly thereon. This is especially beneficial when a redeemed coupon reaches a clearinghouse as a report can quickly be made telling: (i) which coupon was redeemed by which shopper, and (ii) which charity should be paid for each coupon redeemed. In operation, the payment system operated by the online service includes computer systems that: (i) bills the manufacturers a fee based on coupon redemption, and (ii) pays the charitable causes a percentage of the fees billed to the manufacturers.

Importantly, the present invention provides a system that sends money to charitable causes with the charitable causes being pre-selected by the shoppers using the coupons. Simply put, a shopper first picks out what charity or charitable cause they wish to support. Next, the shopper picks out the coupons they want. When they redeem the coupons, the manufacturer of the coupon sends funds to an online coupon management facility who then sends funds through the online system to the selected charitable causes.

When the present invention is used in conjunction with print coupons (in a magazine, periodical, etc.) as well as online coupons, the manufacturer can pay the magazine publisher a commission on actual coupons redeemed (as opposed to simply buying print space within the magazine). This gives the magazine publisher an added incentive to place the coupon at the best possible location so that it is noticed, clipped and redeemed.

Further advantages of the present invention are its ease of use for all parties (manufacturers, shoppers, retailers, coupon clearinghouses, etc). In addition, the present invention provides an online system of coupon redemption that does not require a computer or printer application first being downloaded onto a shopper's computer or smart phone.

### BRIEF DESCRIPTION OF THE DRAWINGS

FIG. 1 is a schematic of a computer network system embodying the present invention.

FIG. 2 is a schematic of various parties interacting with the present computer network system, showing the process a coupon takes moving from one party to another. FIG. 2 also shows the flow of information and funds between the various parties.

FIG. 3 is a schematic showing an overview of system operation.

FIG. 4 is a schematic showing registration of various parties initially using the system.

FIG. 5 is a schematic showing a shopper's interaction with the present system.

FIG. 6 is a schematic showing a manufacturer's interaction with the present system.

FIG. 7 is a schematic showing a charitable cause's interaction with the present system.

FIG. 8 is a schematic showing the coupon redemption reporting process and the associated transfer of funds between parties.

FIG. 9 is a schematic illustrating aggregated coupon tracking information.

FIG. 10 is a schematic illustrating coupon tracking metrics.

FIG. 11 is an illustration of a coupon printed out according to the present invention.

### DETAILED DESCRIPTION OF THE DRAWINGS

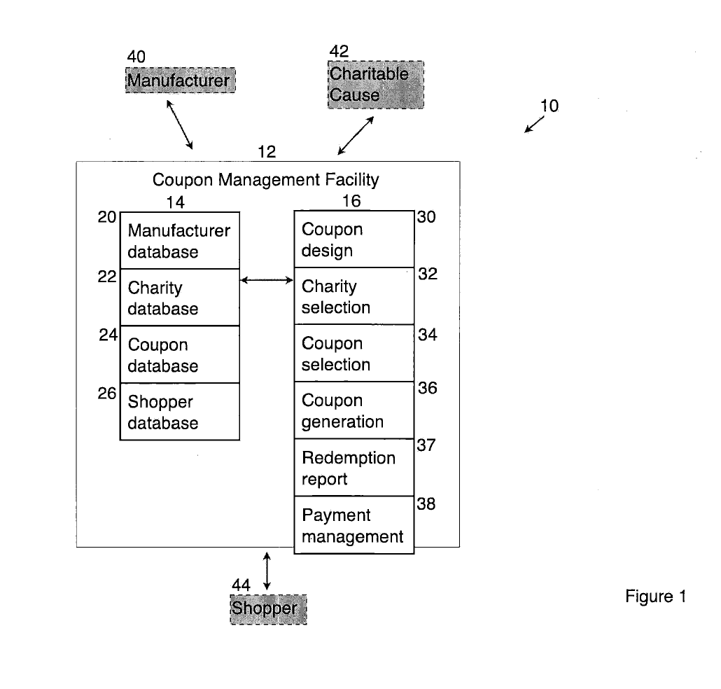

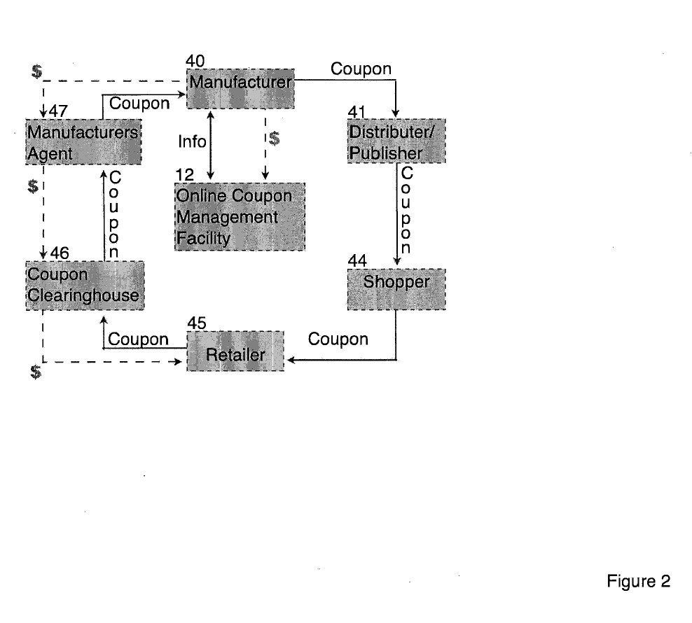

FIG. 1 illustrates the physical components of a computer network embodying the present invention and FIG. 2 illustrates the movement of a coupon as handled by various parties as it moves along during operation of the present invention.

Turning to FIG. 1, a coupon management system 10 is provided that generates, distributes, and tracks coupons for payment of coupon advertising based upon coupon redemption. System 10 comprises an online coupon management facility 12, including a database facility 14 and a computer system 16 linked to database facility 14.

Database facility 14 includes a plurality of separate databases (or separate database files all kept within the same database) including a database (or file) of manufacturers 20, a database (or file) of charitable causes 22, a database (or file) of coupons 24; and a database (or file) of shoppers 26. It is to be understood that databases 20, 22, 24, and 26 may either be one database, physically separate databases at different locations, or they may be separate records all kept within the same physical database, all keeping within the scope of the present invention.

Computer system 16 comprises a plurality of different software modules that are installed therein that operate together to carry out the present invention when different parties interact with them as follows:

A coupon design software module 30 operates an online interface through which manufacturer(s) 40 communicate with central computing facility 12 to design coupons. Once the coupon has been designed, manufacturer 40 then stores the coupon in coupon database 24. Central computing facility 14 stores the identity of each manufacturer 40 in the manufacturer database 20.

A charitable cause selection software module 32 operates a first online interface through which charitable cause(s) 42 communicate with central computing facility 16 to be registered and included within charitable cause database 22, and a second online interface through which each shopper 44 communicates with central computing facility 16 to select their own preferred charitable causes (from among those stored in charitable cause database 22).

A coupon selection software module 34 operates an interface through which shopper(s) 44 communicate with central computing facility 16 to select preferred coupons from among those stored in coupon database 24.

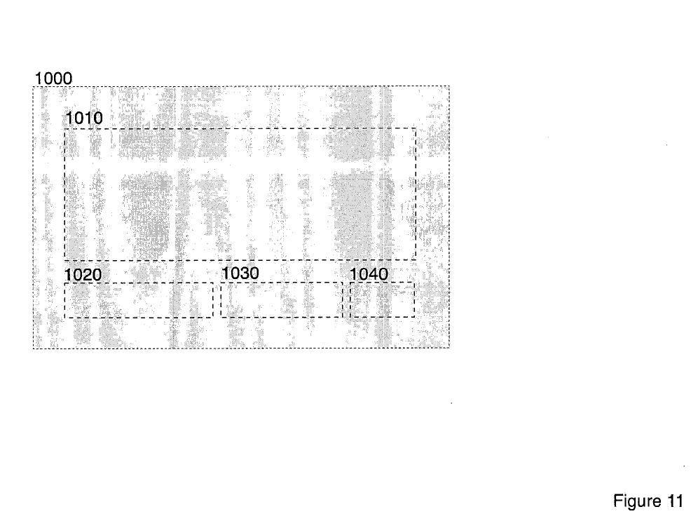

A coupon generating software module 36 generates the final coupon (as seen in FIG. 11) that has data fields attached thereto that: (i) identifies the good or service to which the coupon relates, and (ii) identifies the particular shopper who selected the coupon. Optionally as well, a further data field can be included that: (iii) identifies the charitable cause that the particular shopper has selected. In various aspects, coupon generating software module 36 either sends information to print the coupon to a remote computer operated by shopper 44, or it sends information to print the coupon to a remote computer operated by manufacturer 40. When the information is sent to manufacturer 40, manufacturer 40 may then in turn send the information needed to print the coupons to a distributor such as a magazine publisher. For example, manufacturer 40 first creates coupons on coupon management facility 12. Next, coupon management facility 12 creates print versions of the coupons and submits them to a publisher 41, and manufacturer 40 pays coupon management facility 12 per coupon redeemed. Coupon management facility 12 pays publisher 41. This has the advantage of having facility 12 determining the particular publisher 41 to be used. This can be done automatically through the software of facility 12 such that manufacturer 40 simply designs the coupons and facility 12 then (selects and) contacts the various publishers 41 that would be best suitable to publish the particular coupons. In such a scenario, the coupon design could be sent directly from facility 12 to publisher 41. This particular arrangement may also be set up so that manufacturer 40 can select publisher, publishing dates etc. through the software modules of facility 12 when creating the coupon and then the coupon is placed/submitted to publisher 41 automatically. The advantage of this approach is that manufacturer 40 need only deal with central online facility 12. Thus, the present system provides manufacturers/advertisers 40 with a direct connection channel to access desired media/publishers (without having to deal directly with media buyers, advertising agencies, creative agencies or anyone else that you normally need to go through to place advertisements).

An optional coupon redemption report software module 37 is configured to receive reports of coupon redemption (for example from a coupon clearinghouse or from the manufacturer itself).

An optional payment management software module 38 operates to: (i) bill each manufacturer 40 a fee based on actual redemptions of their coupons, and (ii) pay each charitable cause 42 a percentage of the fees that are billed to the manufacturers.

As seen in FIG. 2, manufacturer 40 communicates with central computing facility 12 to design coupons. As stated above, these coupons can be online coupons that are stored in an online coupon database where they can be viewed by shoppers. In addition, the present invention also encompasses print coupons published in magazines, journals, etc. In the case of print coupons published in magazines, journals, etc., manufacturer 40 may pay a publisher/distributor 41 to print the coupons in its magazine, newspaper, journal, etc. Preferably, however, manufacturer 40 may pay coupon management facility 12 who then pays publisher 41 (as was described above). In this case, shopper 44 sees the coupons and cuts them out of the magazine. The shopper 44 then takes the coupons to a retailer 45 and redeems them. (Thus, shopper 44 may get their coupons either directly from facility 12, or from publisher/distributor 41). Retailer 45 will accumulate a large number of redeemed coupons. Next, these redeemed coupons can be bundled together and sent to a coupon clearinghouse 46. Clearinghouse 46 will produce reports of which coupons have been redeemed. These reports of coupon redemption are then forwarded back to manufacturer 40. These reports may be forwarded directly to manufacturer 40; however, it is likely easier to forward the reports to a manufacturer's agent 47 who then forwards it to manufacturer 40. At this point, the manufacturer then knows how much money they have to pay to each of the various retailers 45. (Each time a coupon is redeemed, the retailer is essentially charging the shopper less than the cost of the item with the manufacturer then being responsible for paying the retailer the difference, being the face value of the coupon).

Importantly, in accordance with the present invention, the coupon generated by the online system itself contains encoded information telling the identity of the shopper. Thus, the coupon redemption reports generated by clearinghouse 46 detail which particular shopper redeemed which particular coupon. This information is then sent back to central computing facility 12, received by coupon redemption report software module 37 and then used by payment management software module 38 to determine how much to: (i) bill manufacturer 40, and (ii) pay charitable cause 42. (Note: when the coupons have been printed by the shopper 44 directly accessing online facility 12, the coupons will be printed with information identifying the shopper. This would not be the case when the shopper simply sees the coupon in a newspaper or journal put into circulation by publisher/distributor 41. However, the present invention can still be used to provide a system where coupon payment is based on actual coupon redemption.)

The basic financial flow in FIG. 2 occurs with: (i) manufacturer 40 paying the operator of central computing facility 12; (ii) manufacturer 40 paying retailer 45; and (iii) the operator of central computing facility 12 paying charitable cause 42, as follows:

First—manufacturer 40 pays the operator of central computing facility 12 when its coupons are actually redeemed. Thus, there are no charges to the manufacturer to design the coupons or to load the coupons online Nor are there any charges to the manufacturer when coupons are simply viewed by shoppers or even when shoppers print the coupons. Instead, payment is based solely on coupon redemption. Only when a coupon has been redeemed is the manufacturer responsible to pay the operator of central computing facility 12 for use of the present system.

Second—manufacturer 40 must pay retailer 45 for accepting the coupon. For example, if the coupon says “save $1 by using this coupon”, then retailer 45 charges shopper 44 $1 less than they would otherwise charge for the good or service in the absence of the coupon. Manufacturer 40 must then pay retailer 45 this $1 difference. It is to be understood that although manufacturer 40 could pay retailer 45 directly, this would likely not commonly be the case. Instead, manufacturer 40 likely pays their agent 47 which in turn pays clearinghouse 46 which in turn pays retailer 45. It is to be understood that the present invention includes all methods of making payment through various systems, channels or intermediaries provided that manufacturer 40 pays retailer 45 for the coupons that are redeemed.

Third—the operator of central computing facility 12 pays a percentage of the money it has received from manufacturer 40 directly to a pre-selected charitable cause 42. Importantly, the particular charitable cause 42 to which the payments are made are the exact charitable causes that the shopper 44 has pre-selected (at the time of printing the coupon) to financially support.

In another aspect, the present invention also encompasses the preferred method of generating coupons, tracking coupon redemption and paying for coupon advertising based upon coupon redemption, comprising the steps of:

(a) manufacturer 40 designing a coupon using online facility 12;

(b) manufacturer 40 making the coupon available to shopper 44 (either online, in a printed publication, or both);

(c) shopper 44 redeeming the coupon at retailer 45;

(d) retailer 45 sending the redeemed coupon to clearinghouse 46;

(e) clearinghouse 46 making a report of the coupon redemption, wherein the report includes the identity of the shopper redeeming the coupon;

(f) the report of the coupon redemption being sent from clearinghouse 46 to both manufacturer 40 and online coupon management facility 12:

(g) manufacturer 40 paying retailer 45 based upon the redemption of the coupon; and

(h) manufacturer 40 paying online coupon management facility 12 based upon the redemption of the coupon.

The above step (f) of sending the report of the coupon redemption to the manufacturer 40 and online coupon management facility 12 may optionally comprise: (i) the clearinghouse sending the report only to the manufacturer who then sends it to the online coupon management system, (ii) the clearinghouse sending the report only to the online coupon management system who then sends it to the manufacturer, or (iii) the clearinghouse sending the report to both the manufacturer and the online coupon management system. Optionally, sending the report of the coupon redemption from clearinghouse 46 to manufacturer 40 may comprise: clearinghouse 46 sending the report to manufacturer's agent 47; and manufacturer's agent 47 then sending the report to manufacturer 40. Optionally, sending the report of the coupon redemption may comprise: retailer 45 sending the report to the manufacturer 40, or retailer 45 sending the report to both the manufacturer 40 and the online coupon management facility 12.

As was described above, this preferred method preferably further comprises:

(i) shopper 44 pre-selecting a charitable cause 42 from a listing of charitable causes pre-registered with online coupon management system 12; and

(j) online coupon management facility 12 paying the pre-selected charitable cause 42 based upon the redemption of the coupon.

As stated above, the present invention encompasses using both print and online coupons, and even both together. Thus, for online coupons, manufacturer 40 makes the coupon available to shoppers by posting the coupon online at a website hosted by online coupon management facility 12. It is to be understood that the present coupon may be posted to a website, widget, mobile application, etc. The actual coupon that is printed by shopper 44 will contain the identity of the shopper in information printed thereon. In the case of print coupons, manufacturer 40 makes the coupon available to shoppers by having a publisher/distributor 41 print the coupon in a magazine, newspaper, journal, flyer or periodical. When a distributor 41 is used, manufacturer 40 can pay the distributor based upon the actual redemption of the coupon. Or, more preferably, manufacturer 40 can pay facility 12 who will then pay the distributor 41.

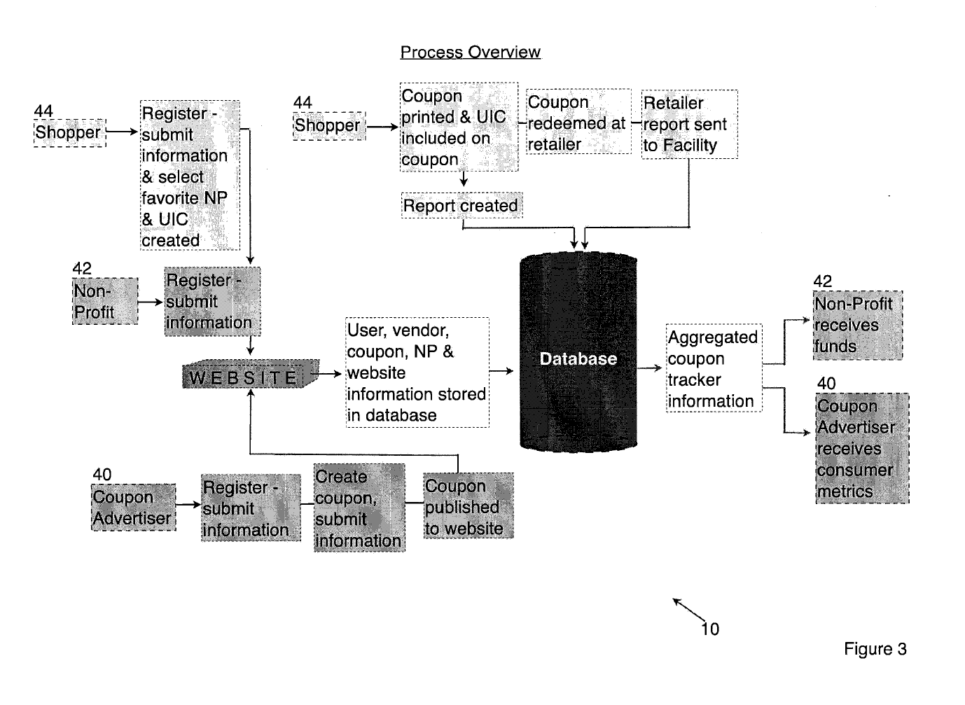

FIG. 3 shows an overview of the basic process in which a shopper 44, charitable cause 42 and manufacturer 40 each interact with facility 12. For example, each shopper 44 accesses the system through a website and online interface in which they register and select their favorite charity 42. Note, the shopper may simply select one or more charitable causes 42 to support. Alternatively, the shopper may support different charities for different kinds of coupons, etc. Each of the various charitable causes 42 also access the system through a website and online interface in which they register to be included in database 22. In addition, each of the various manufacturers 40 also register with the system. Next, they create their coupons using the software provided by system 10 (or optionally by software provided by others). Finally, these finished coupons are stored in the system's coupon database 24 and published to a website (for viewing by potential shoppers). As explained above, system 12 then stores shopper information in database 26, coupon information in database 24, and charitable cause (e.g.: “non-profit) information in database 22 (see FIG. 1).

Following initial registration, a shopper 44 returns to use the system. At this time, the user selects and prints a coupon (from among the coupons in coupon database 24). Importantly, the coupon is printed with data identifying the particular shopper 44 printed thereon. For confidentiality and for ease of scanning, this identifying data may be encrypted and printed in a bar code format. (This may be as simple as a number that corresponds to a particular shopper's identification in the system's shopper database 26). After printing out the coupon, shopper 44 then takes the coupon to a retailer (45 in FIG. 2) where the coupon is redeemed. The retailer then sends all redeemed coupons to a coupon clearinghouse. A report of coupon redemption is then generated by the coupon clearinghouse (46 in FIG. 2). This redemption report is forwarded back to facility 12 (directly or through the manufacturer or manufacturer's agent). Next, all of this data is aggregated by facility 12. At this stage, a portion of the funds received by facility 12 is forwarded to various charitable causes 42. In addition, detailed consumer metrics are prepared by facility 12 and sent to manufacturer 40.

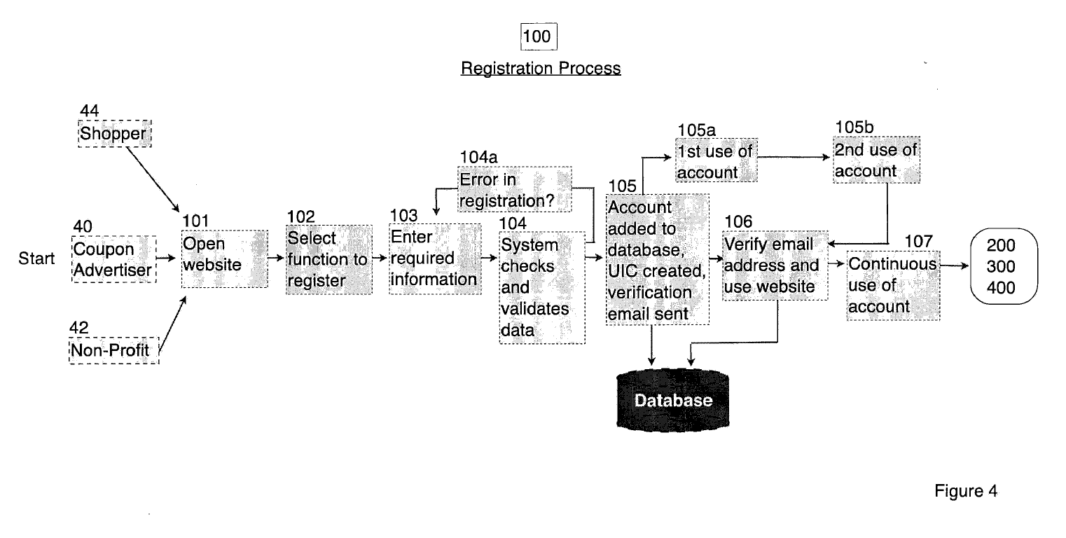

Turning next to FIG. 4, the registration process 100 for each of shopper 44, manufacturer 40 and charitable cause 42 is shown. Specifically, each of these three parties interacts with facility 12 through various online interfaces, as follows. First, at step 101, the respective party opens the website. At step 102, the party selects functions to register (i.e.: they identify themselves as being a manufacturer, shopper or charitable cause). Next, at step 103, the respective party enters the required identifying information that they are prompted to enter.

Typical data fields that shopper 44 may have to fill out may include: first and last name, email address, gender, birthday, zip code, country and favorite charitable cause(s). Typical data fields that manufacturer 40 may have to fill out may include: business name, contact person's name, phone number, email, address, etc., EIN Tax Number, website, and type of business. Typical data fields that charitable cause 42 may have to fill out may include: name of organization, contact person's name, phone number, email, address, etc., EIN Tax Number, website, and type of business. Additional fields (to lure shoppers to support them) may also be included.

Next, at step 104, facility 12 then validates the entered information. Should there be a problem, step 104A will be taken to re-enter the information. At step 105, the entered account information is added to the various system databases. For example, in the case of shoppers 44, their information will be entered and then stored in database 26. The charitable cause 42's information will be entered and then stored in database 22. Similarly, the manufacturer 40's information will be entered and then stored in database 20. At optional step 105A, the new user can be granted access the first time without having to verify their email address. The second time they use the system, at step 105B, they can be required to verify their email address. (This has the advantage of permitting new users to quickly access the website and coupons and not be bothered with email verification until their second visit). Next, at step 106, system 12 validates the respective party's email address and permits the party to continuously use their new account.

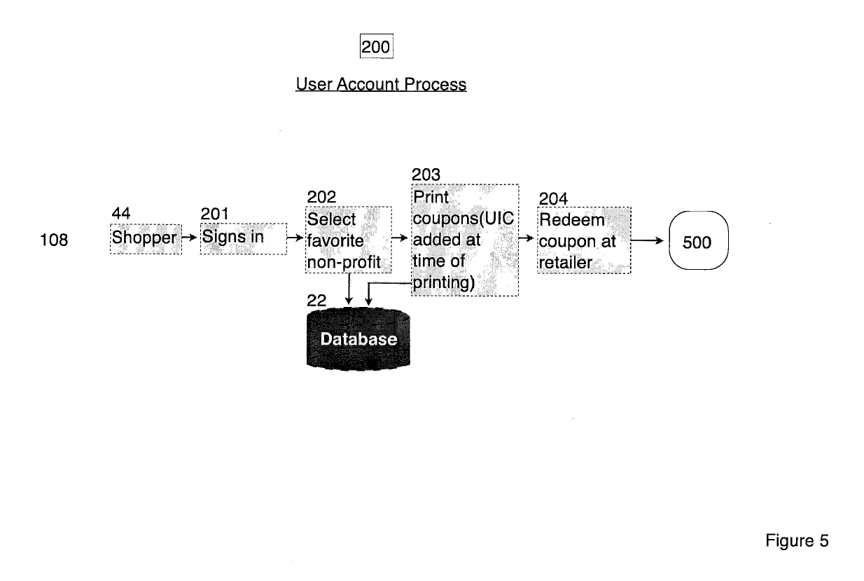

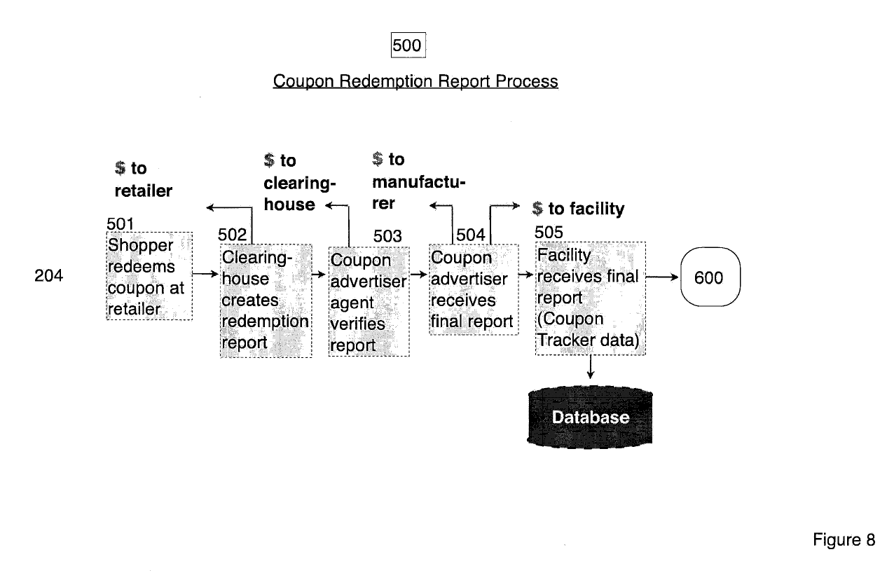

FIG. 5 illustrates the continuation of the process shown in FIG. 4, but from the perspective of a shopper 44 (i.e.: after they have already registered with the system as detailed in FIG. 4). Process 200 operates as follows. Shopper 44 signs in at step 201. Next, at step 202, they select their favorite charitable cause(s) 42 (from those stored in charitable cause database 22). Next, shopper 44 prints their selected coupons at step 203. Facility 12 (and specifically its coupon generating software module 36) ensures that the coupons are printed with data thereon identifying the particular shopper who printed the coupon. Next, at step 204, shopper 44 takes their coupon to a retailer 45 and redeems the coupon (continuing with the coupon redemption process 500 as will be described in FIG. 8 below).

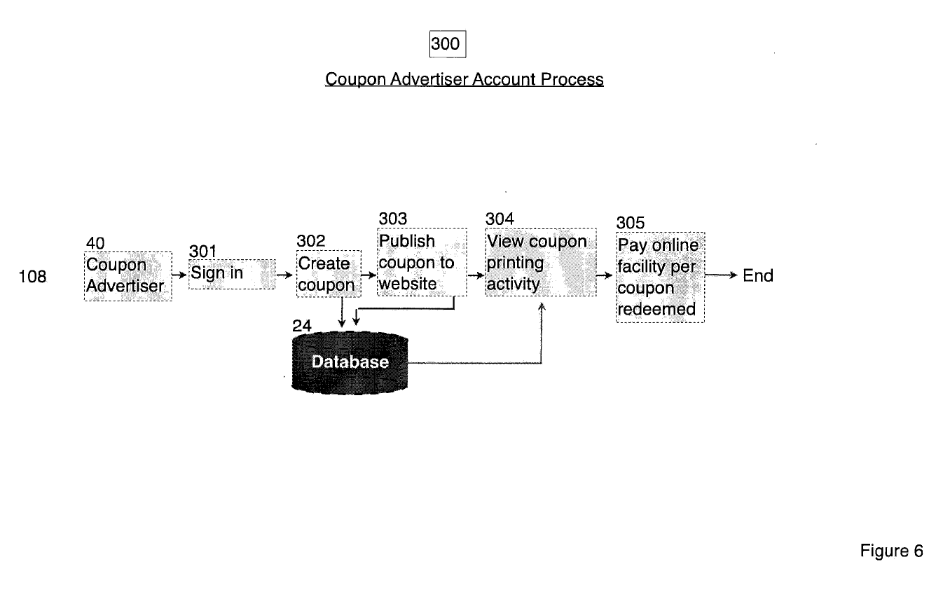

FIG. 6 illustrates the continuation of the process shown in FIG. 4, but from the perspective of a manufacturer 40 (i.e.: after they have already registered with the system as detailed in FIG. 4). Process 300 operates as follows. Manufacturer 40 signs in at step 301. Next, at step 302, they design and create a coupon. The coupon is added to coupon database 24. Next, at step 303, they publish the coupon to a website where shoppers 44 can view, search, select and print the coupon. At step 304, the manufacturer 40 can optionally view coupon printing activity (compiled by facility 12). Finally, at step 305, the manufacturer 40 pays online system 12 a fee based on the actual redemption of the coupon.

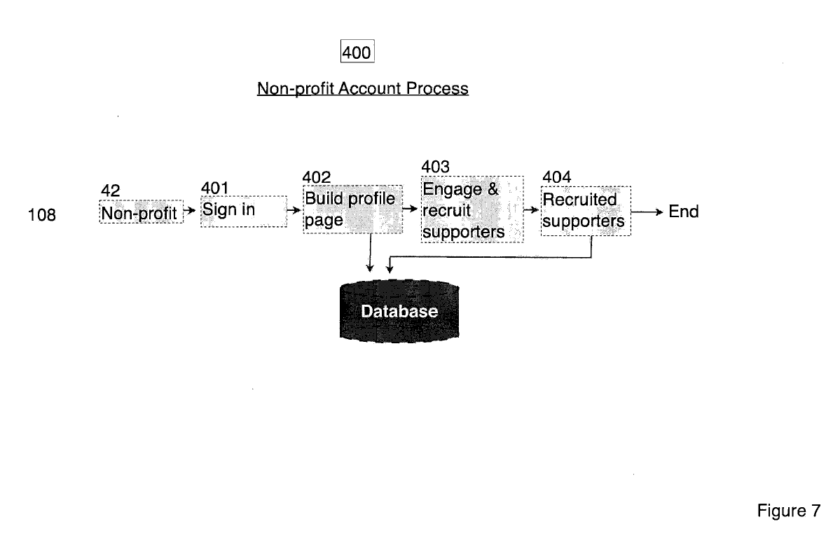

FIG. 7 illustrates the continuation of the process shown in FIG. 4, but from the perspective of a charitable cause 42 (i.e.: after they have already registered with the system as detailed in FIG. 4). Process 400 operates as follows. Charitable cause 42 signs in at step 401. Next, at step 402, they build a profile page. This may involve a business tag line, a description of the charitable cause's work, services offered by the charitable cause, events on the charitable cause's upcoming calendar, and “tips” or “quotes” from the charitable cause, etc. At step 403, charitable cause 42 may engage and recruit supporters (i.e.: persuade shoppers 44 to select them as their preferred charitable cause to support with coupon redemption). These supporters/shoppers 44 are then recruited at step 404.

FIG. 8 illustrates the coupon redemption reporting process 500 as follows. First, at step 501, a shopper 44 takes their coupon to a retailer 45 and redeems the coupon. Typically, the shopper will pay a price for an item that equals the marked price less the coupon value (with the manufacturer then later reimbursing the retailer for the face value of the coupon). Retailer 45 then assembles all the coupons that have been redeemed at their store and bundles them up and sends them to clearinghouse 46. At step 502, clearinghouse 46 then creates a report of the coupon redemption (importantly, this report will include the identities of each shopper matched with the particular coupons that they redeemed). The coupon redemption report is then sent from clearinghouse 46 to manufacture's agent 47 who verifies the report at step 503. Next, at step 504, the coupon redemption report is sent from manufacturer's agent 47 to manufacturer 40. Concurrently, manufacturer 40 pays its agent 47 for verifying the coupon redemption report. The manufacturer's agent 47 in turn pays clearinghouse 46 for compiling and preparing the redemption report. Finally, clearinghouse 46 in turn pays retailer 45 to cover the redemption cost of the coupon.

At step 505, the manufacturer 40 also sends the coupon redemption report to the operator of facility 12. In addition, manufacturer 40 also sends payment to system 12 for use of the service. In accordance with the present invention, the payment sent from manufacturer 40 to system 12 is based on actual coupon redemption as set forth in the coupon redemption report itself. Facility 12 then stores the coupon redemption report in its databases. Upon receiving the coupon redemption report, facility 12 (under the control of its payment management software module 38) then calculates the payment system 12 will then make to each charitable cause 42.

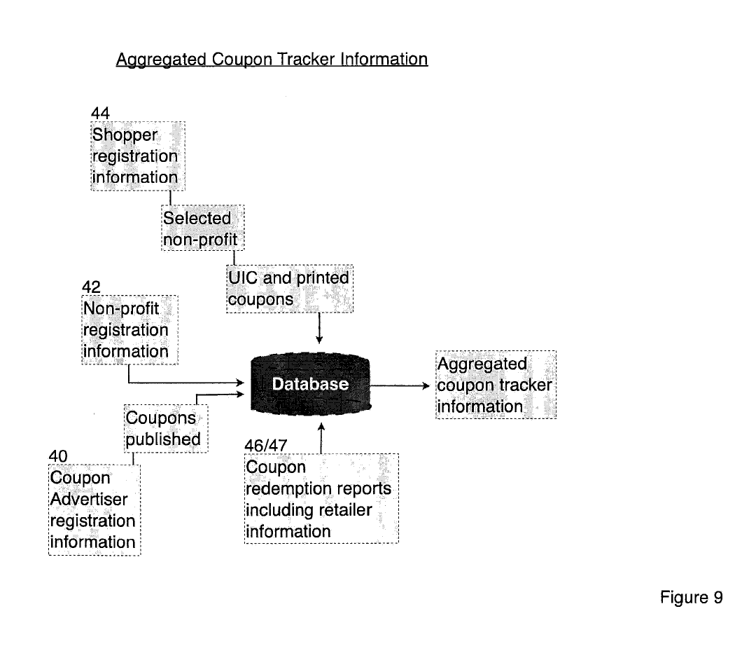

FIG. 9 shows the flow of aggregated coupon tracker information from the various parties (shoppers 44, manufacturers 40, charitable causes 42 and clearinghouses 46/agents 47) that is stored in databases in facility 12. For example, shopper 44 registers, selects their preferred charitable causes, and then prints their selected coupons. All of this information is recorded in shopper database 26. Charitable causes 42 also register with facility 12. Manufactures 40 register and then create coupons which are published (online or in print). Lastly, the information contained in the coupon redemption reports coming from clearinghouses 46 and/or manufacturer's agents 47 is also recorded in databases in facility 12. From all this data, aggregated coupon tracking information and metrics is performed.

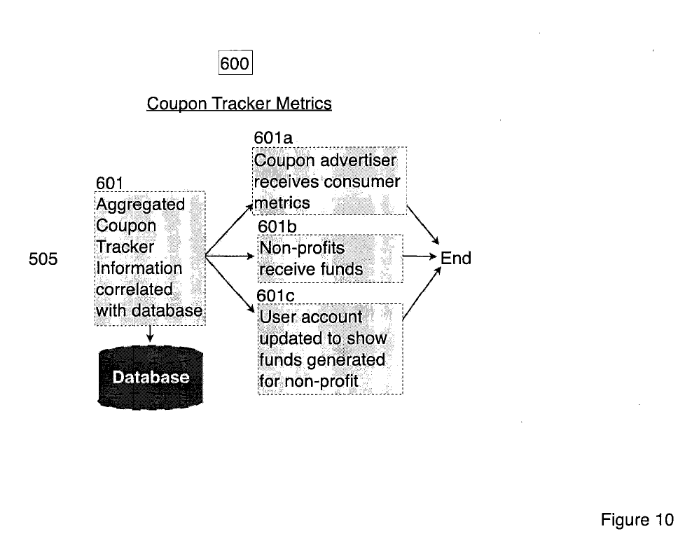

FIG. 10 illustrates this process 600 of coupon tracker metrics, as follows. Specifically, the aggregated coupon tracker information at 601 (and stored in databases in facility 12) can be compiled to show a manufacturer 40 which particular coupons are redeemed by which particular shopper 44 at 602A. Compiled data on which charitable causes receive funds (and the amounts they receive) is provided at 602B. Lastly, at 602C, shopper accounts can be updated such that individual shoppers 44 can log on and view their accounts to see which charitable causes they have funded and in what amounts. Aggregated coupon data about retailers can include the identity of the retailers (which yields data on what stores the shoppers redeem their coupons at, how often they redeem them and exactly what stores they shop to use their various coupons). This information can be useful to retailers as well in terms of knowing what goods to stock. In addition, all of the information recorded by the present system as consumer metrics creates an unparalleled consumer profile and purchasing profile based on actual redemption of coupons. This is extremely valuable to advertisers/manufacturers using the present system.

FIG. 11 illustrates an exemplary coupon produced and printed according to the present invention. Coupon 1000 may be made of paper or any other suitable material. Coupon 1000 has several data fields thereon. Field 1010 simply identifies the good or service to which the coupon relates and the face value of the coupon. This field would likely also include a picture of the product. For example, field 1010 may simply be a picture of a bar of Dove® soap, and say “$1 off Dove® soap”. Field 1010 is the information that the shopper 44 and retailer 45 look at when the coupon is redeemed in the store. Field 1010 may therefore cover almost all of the face of the coupon. Field 1020 is the data field that identifies the particular shopper 44 who printed the coupon. Preferably data field 1020 is a bar code (or other data code) or a number corresponding to the identity of the shopper in the system's database. Field 1020 may preferably be encoded for confidentiality purposes (for example, such that it is not merely the printed name of the shopper). For example, facility 12 may generate a unique User Identity Code (UIC) for each shopper. This UIC is preferably encrypted before being printed on the coupon.

When data field 1020 is read by clearinghouse 46 (i.e.: after the coupon is redeemed and sent from the retailer to the clearinghouse), the information in data field 1020 is used to identify which particular shopper redeemed which particular coupon. Lastly, a data field 1030 may also optionally be included on the coupon identifying which charitable cause(s) the shopper has chosen to support with their coupon purchases. When data field 1030 is read by clearinghouse 46, this information is sent back to system 12 such that payment can be made from system 12 to the charitable cause(s) of choice. It is to be understood, however, that data field 1030 is optional. For example, if coupon 1000 is printed without data field 1030, system 12 would still be able to identify which charitable causes the shopper wished to support based on information already stored in its database for that particular shopper. Thus, all that is required in accordance with the present invention is a coupon that has information printed thereon identifying the shopper who will redeem the coupon.

Data associated with coupon 1000 (and printed thereon) may include: the manufacturer's name, the offer or face value of the coupon, a description of the coupon's offer, terms of the coupon (such as expiry date, limits on number per customer, geographic areas, etc.); the time limits during which the coupon is valid, etc. This data can be printed on the coupon in words, photos or barcodes (including but not limited to GS1 or UPCA barcodes).

Preferably, the coupons themselves may have links or user scannable fields 1040 that will encourage the shopper to visit the online coupon gallery hosted by facility 12. This is particularly useful in the case of print coupons that the shopper encounters by chance in newspapers, periodicals, etc. as this “bridges” the shopper from the limited number of print coupons to an unlimited number of online coupons. Moreover, the actual publisher of such print coupons can earn more by sharing in coupon redemption than by simply selling advertising space. In addition, the publisher could earn a portion of the redemption revenue from those readers who “bridged” into the online coupon gallery website. Thus, the publisher can potentially earn more money by sharing in coupon redemption revenue than they could from the sale of the physical ad space to the advertiser. Having coupons in a magazine makes the magazine more attractive to purchasers. This is simply because the cost of the magazine can be offset against the money that can be saved by redeeming the coupons therein. In accordance with the present invention, printed coupons may be a “feature” of the magazine. For example, they may be consistently placed in the corners or edges of the magazine to be easy to tear out. By providing readers easy to find uniform coupons that are easy to tear out, readers will be more inclined to buy the magazine since they will be attracted to the savings offered by the coupons. This benefits the magazine as more readers will be attracted to buying it.

The present invention also encompasses a novel system of fraud prevention, as follows. Since each printed coupon has a unique shopper identifier printed thereon, if the shopper attempted to redeem more coupons than allowed, or to redeem a fraudulent coupon, their identity would immediately be known. No existing coupon system can combat fraud in this manner. In addition each consumer can only print a defined number of prints per coupon in a defined space in time such as one coupon every two weeks. Of course, like all other coupons a person can print it once and take it to a copier to make multiple coupons. However a coupon generated using the present system has the person's ID on each coupon and can therefore track the person if they do multiple copies. Each coupon may also be printed with redemption limits included in the terms such as one per customer.

Yet another optional feature of the present invention is that the coupons have video links when viewed online. Thus, shoppers can optionally play videos accompanying the coupons. Such videos may promote or better explain the product or service (so users can learn about the product or service before they purchase a coupon for it). Charitable causes may also wish to add video links to better explain or promote their work to potential shoppers/supporters.

Advantageously, the information in the coupon redemption reports is reconciled by facility 12 to all of the fields of information for each coupon provided by retailer 45, manufacturer 40 and the shopper 44 who redeemed the coupon. This allows facility 12 to pay the appropriate charitable cause 42 selected by each shopper who redeems a coupon, and allows facility 12 to coalesce information fields from multiple sources such as retailers, advertisers and registered shoppers to gather shopper behavior insights.

In yet another aspect of the present invention, a referral system is provided such that shoppers 44 can refer their friends to facility 12. This referral system will track the connections between the first shopper 44A and their friends/family/coworkers 44B, 44C, etc. Thus, the consumer metrics provided by the present system could include not only detailed listings of which shoppers redeem which coupons at which retailers at which times. Instead, the consumer metrics could also include information as to which particular shoppers are referring others to the present online system. This is a huge benefit to manufacturers/advertisers since they would be able to identify which shoppers are both using their coupons and are telling others about them. In optional aspects of the present invention, extra rewards or incentives (i.e.: special or extra coupons) could be provided to those particular shoppers that are found to be referring other shoppers to use the present system (or those buying from a particular manufacturer/advertiser or to those supporting a specific charitable cause). Thus, the referring shopper receives an extra benefit (in the form of special or extra coupons); the manufacturer/advertiser receives an extra benefit (in the form of detailed consumer metrics including referral information). In this optional system, the shoppers can be given a detailed report of the shoppers that they have referred, and see whether these other shoppers have actually used the system. Optionally as well, the shopper can be paid a referral fee for each coupon redeemed by one of the persons they have referred to the system. Optionally, shoppers can be paid a reward fee per coupon that they redeem themselves and also be paid a reward fee per coupon redeemed by the shoppers they referred. Finally, the charitable causes also receive an extra benefit (in the form of knowing which shoppers are referring others to support their causes provided that such detailed consumer metrics are given to the charitable causes).

What is claimed is:

1. A method of generating coupons, tracking coupon redemption and paying for coupon advertising based upon coupon redemption, comprising the steps of:
(a) a manufacturer designing a coupon using an online coupon management system;
(b) the manufacturer making the coupon available to a shopper;
(c) the shopper redeeming the coupon at a retailer;
(d) the retailer sending the redeemed coupon to a clearinghouse;
(e) the clearinghouse making a report of the coupon redemption, wherein the report includes the identity of the shopper redeeming the coupon;
(f) the report of the coupon redemption being sent from the clearinghouse to both the manufacturer and to the online coupon management system;
(g) the manufacturer paying the retailer based upon the redemption of the coupon; and
(h) the manufacturer paying the online coupon management system based upon the redemption of the coupon.

2. The method of claim 1, further comprising:
(i) the shopper registers and fills out multiple fields of information including pre-selecting a charitable cause from a listing of charitable causes participating with the online coupon management system; and
(j) the online coupon management system paying the pre-selected charitable cause based upon the redemption of the coupon.

3. The method of claim 2, wherein the online coupon management system pays the pre-selected charitable cause a percentage of the payment the online coupon management system receives from the manufacturer.

4. The method of claim 1, wherein the manufacturer makes the coupon available to the shopper by posting the coupon online via the online coupon management system to the interne, to a website, widget, mobile applications or social media networks.

5. The method of claim 1, wherein the manufacturer makes the coupon available to the shopper by having a distributor or publisher print the coupon in a magazine, newspaper, journal, flyer or periodical.

6. The method of claim 5, wherein the manufacturer makes the coupon available to the shopper by selecting, or having the online coupon management system select, a distributor or publisher to print the coupon in a magazine, newspaper, journal, flyer or periodical.

7. The method of claim 5, further comprising:
(i) the manufacturer paying the distributor or publisher based upon the redemption of the coupon.

8. The method of claim 7, wherein the manufacturer pays the online coupon management system, and the online coupon management system then pays the distributor or publisher.

9. The method of claim 1, wherein sending the report of the coupon redemption from the clearinghouse to the manufacturer comprises:
(i) the clearinghouse sending the report to a manufacturer's agent; and
(j) the manufacturer's agent sending the report to the manufacturer.

10. The method of claim 1, wherein the manufacturer paying the retailer based upon the redemption of the coupon comprises:
(i) the manufacturer paying the clearinghouse based upon the redemption of the coupon; and
(j) the clearinghouse paying the retailer based upon the redemption of the coupon.

11. The method of claim 4, wherein online coupon management system generates the coupon for printing by the shopper such that the printed coupon contains the identity of the shopper in information printed thereon.

12. The method of claim 1, wherein the report of the coupon redemption is sent from the clearinghouse to the manufacturer and then from the manufacturer to the online coupon management system.

13. The method of claim 1, wherein the online coupon management system bills the manufacturer a fee based on the redemption of the coupon.

14. The method of claim 13, wherein the online coupon management system pays the charitable cause a percentage of the fee billed to the manufacturer.

15. A coupon printed for redemption with information thereon, comprising:
a printed coupon; and
information printed on the coupon, wherein the information comprises data fields:
(a) representing a good or service to which the coupon relates; and
(b) representing the identity of a shopper who printed the coupon.

16. The coupon of claim 15, wherein the information printed on the coupon further comprises a data field:
(c) representing the identity of a charitable cause that has been pre-selected by the shopper for fiscal support upon redemption of the coupon.

17. The coupon of claim 15, wherein the coupon is printed on paper.

18. The coupon of claim 15, wherein the data fields are printed as bar codes.

19. The coupon of claim 15, wherein the data fields are printed as data codes.

20. A coupon management system for generating, distributing and tracking coupons for payment of coupon advertising based upon coupon redemption, comprising:
(a) a central computing facility, comprising:
(i) a database facility, comprising:
(a) a database of manufacturers,
(b) a database of charitable causes,
(c) a database of coupons; and
(d) a database of shoppers, and
(ii) a computer system linked to the database facility, the computer system comprising:
(a) a coupon design software module installed in the computer system, wherein the coupon design software module operates an online interface through which manufacturers communicate with the central computing facility to design coupons and store the coupons in the database of coupons, and wherein the central computing facility stores the identity of the manufacturers in the database of manufacturers,
(b) a charitable cause selection software module installed in the computer system, wherein the charitable cause selection software module operates a first online interface through which charitable cause communicate with the central computing facility to be included in the database of charitable causes, and a second online interface through which shoppers communicate with the central computing facility to select preferred charitable causes that are stored in the database of charitable causes,
(c) a coupon selection software module installed in the computer system, wherein the coupon selection software module operates an interface through which the shoppers communicate with the central computing facility to select preferred coupons stored in the database of coupons, and
(d) a coupon generating software module installed in the computer system, wherein the coupon generating software module generates a coupon that has data fields attached thereto that: (i) identifies a good or service to which the coupon relates, and (ii) identifies the shopper who selected the coupon.

21. The coupon management system of claim 20, wherein the coupon generating software module generates a coupon that has a data fields attached thereto that also: (iii) identifies the charitable cause that the shopper has selected.

22. The coupon management system of claim 20, wherein the coupon generating software module sends information to print the coupon to a remote computer operated by the shopper, and wherein the shopper prints the coupon from the remote computer.

23. The coupon management system of claim 20, wherein the coupon generating software module sends information to print the coupon to a remote computer operated by the manufacturer, and wherein the manufacturer prints the coupon from the remote computer.

24. The coupon management system of claim 20, wherein the computer system further comprises:
(e) a coupon redemption report software module installed in the computer system, the coupon redemption report software module configured to receive reports of coupon redemption, wherein the reports identify both the coupons redeemed and the shoppers who redeemed; and
(f) a payment management software module installed in the computer system, wherein the payment management software module: (i) bills the manufacturers a fee based on coupon redemption, and (ii) pays the charitable causes a percentage of the fees billed to the manufacturers.

25. The coupon management system of claim 24, wherein the coupon redemption report software module provides consumer metrics that include the identities of the shoppers redeeming the coupons, the coupon information, the identity of the manufacturer/advertiser, the identity of the retailer where the coupons were redeemed and the time the coupons were redeemed.

26. A coupon management system for generating, distributing and tracking coupons for payment of coupon advertising based upon coupon redemption, comprising:
(a) a coupon design software module which operates an online interface through which manufacturers design coupons and stores the coupons in a coupon database;
(b) a charitable cause software module which operates an online interface through which charitable causes are entered into a charitable cause database and through which shoppers select preferred charitable causes from the charitable cause database;
(c) a coupon selection software module which operates an online interface through which shoppers select preferred coupons stored in the coupon database; and
(d) a coupon generation module that retrieves coupons selected by the shoppers and adds information to the coupons identifying the shopper who selected each coupon.

27. The coupon management system of claim 26, further comprising:
(e) a coupon printing software module that operates a printer to print the coupons, wherein each coupon has information printed thereon: (i) representing a good or service to which the coupon relates; and (ii) representing the identity of a shopper who printed the coupon.

28. The coupon management system of claim 27, wherein the coupon further has information printed thereon: (iii) representing a charitable cause that has been selected by the shopper.

29. The coupon management system of claim 25, further comprising:
(e) a coupon redemption report software module installed in the computer system to receive reports of coupon redemption; and
(f) a payment management software module installed in the computer system configured to: (i) bill the manufacturers a fee based on coupon redemption, and (ii) pay the charitable causes a percentage of the fees billed to the manufacturers.

30. The coupon management system of claim 29, wherein the coupon redemption report software module provides consumer metrics that include the identities of the shoppers redeeming the coupons, the coupon information, the identity of the manufacturer/advertiser, the identity of the retailer where the coupons were redeemed and the time the coupons were redeemed.
